(19) United States
(12) Patent Application Publication
(10) Pub. No.: US 2014/0285794 A1
(43) Pub. Date: Sep. 25, 2014

(54) MEASURING DEVICE

(71) Applicant: KABUSHIKI KAISHA TOSHIBA, Tokyo (JP)

(72) Inventors: Satoshi ITO, Kawasaki-shi (JP); Akihito SEKI, Yokohama-shi (JP); Masaki YAMAZAKI, Tokyo (JP); Yuta ITOH, Kawasaki-shi (JP); Hideaki UCHIYAMA, Kawasaki-shi (JP)

(73) Assignee: KABUSHIKI KAISHA TOSHIBA, Tokyo (JP)

(21) Appl. No.: 14/196,018

(22) Filed: Mar. 4, 2014

(30) Foreign Application Priority Data
Mar. 25, 2013 (JP) 2013-062546

(51) Int. Cl. G01B 11/14; G01B 11/24

(52) U.S. Cl. CPC G01B 11/14; G01B 11/24
USPC 356/73

(57) ABSTRACT

According to an embodiment, a measuring device includes an imaging unit to capture an object from a plurality of positions to obtain a plurality of images; a distance measuring unit to measure a distance to the object from each position to obtain a plurality of pieces of distance information; a position measuring unit to measure each position to obtain a plurality of pieces of position information; a first calculator to calculate three-dimensional data of the object using the images; a second calculator to calculate a degree of reliability of each piece of distance information and each piece of position information; and a estimating unit to, among the pieces of distance information and the pieces of position information, make use of such pieces of distance information and such pieces of position information which have the degree of reliability greater than a predetermined value to estimate the scale of the three-dimensional data.

### CROSS-REFERENCE TO RELATED APPLICATION(S)

This application is based upon and claims the benefit of priority from Japanese Patent Application No. 2013-062546, filed on Mar. 25, 2013; the entire contents of which are incorporated herein by reference.

### FIELD

Embodiments described herein relate generally to a measuring device.

### BACKGROUND

Typically, a technology is known in which an object is captured for a number of times with a single camera (a monocular camera); a plurality of captured images is used to generate three-dimensional data of the object; and the three-dimensional shape of the object is measured using the three-dimensional data that has been generated. In such a method of measuring the three-dimensional shape with the use of a monocular camera, the three-dimensional data of the object is often represented in the camera coordinate system. For that reason, the real-world measurement of the three-dimensional data of the object remains unknown.

In that regard, a technology is known by which the imaging positions of the camera are obtained using the global positioning system (GPS), and the real-world measurement of the three-dimensional data of the object is determined by referring to the movement distance of the imaging positions.

However, in the abovementioned technology, the error in position measurement of the measuring device remains constant regardless of the movement distance thereof. For that reason, when the movement distance of the measuring device is short, the error in position measurement becomes relatively larger. As a result, it is not possible to accurately obtain the scale which is used in determining the real-world measurement of the three-dimensional data of the object.

### BRIEF DESCRIPTION OF THE DRAWINGS

FIG. 1 is a configuration diagram illustrating an example of a measuring device according to a first embodiment;

FIG. 2 is a diagram illustrating an example of distance information and position information according to the first embodiment;

FIG. 3 is a diagram illustrating an example of position orientation information according to the first embodiment;

FIG. 4 is an explanatory diagram illustrating an exemplary method of calculating the degree of reliability of a piece of distance information according to the first embodiment;

FIG. 5 is an explanatory diagram illustrating an exemplary method of calculating the degree of reliability of a piece of distance information according to the first embodiment;

FIG. 6 is an explanatory diagram illustrating an exemplary method of calculating the degree of reliability of a piece of distance information according to the first embodiment;

FIG. 7 is an explanatory diagram illustrating an exemplary method of calculating the degree of reliability of a piece of position information according to the first embodiment;

FIG. 8 is an explanatory diagram illustrating an exemplary method of calculating the degree of reliability of a piece of position information according to the first embodiment;

FIG. 9 is an explanatory diagram illustrating an exemplary method of calculating the degree of reliability of a piece of position information according to the first embodiment;

FIG. 10 is a diagram illustrating an exemplary likelihood distribution according to the first embodiment;

FIG. 11 is a flowchart for explaining an exemplary sequence of operations performed according to the first embodiment;

FIG. 12 is a configuration diagram illustrating an example of a measuring device according to a second embodiment;

FIG. 13 is a flowchart for explaining an exemplary sequence of operations performed according to the second embodiment; and

FIG. 14 is a block diagram illustrating a hardware configuration of the measuring device according to the embodiments.

### DETAILED DESCRIPTION

According to an embodiment, a measuring device includes an imaging unit, a distance measuring unit, a position measuring unit, a first calculator, a second calculator, and an estimating unit. The imaging unit captures an object from a plurality of positions to obtain a plurality of images. The distance measuring unit measures a distance to the object from each of the plurality of positions to obtain a plurality of pieces of distance information. The position measuring unit measures the plurality of positions to obtain a plurality of pieces of position information. The first calculator calculates three-dimensional data of the object using the plurality of images. The second calculator calculates a degree of reliability of each of the plurality of pieces of distance information and each of the plurality of pieces of position information. From among the plurality of pieces of distance information and the plurality of pieces of position information, the estimating unit makes use of pieces of distance information and pieces of position information each having the degree of reliability greater than a predetermined value to estimate a scale of the three-dimensional data.

Exemplary embodiments of the invention are described below in detail with reference to the accompanying drawings.

### First Embodiment

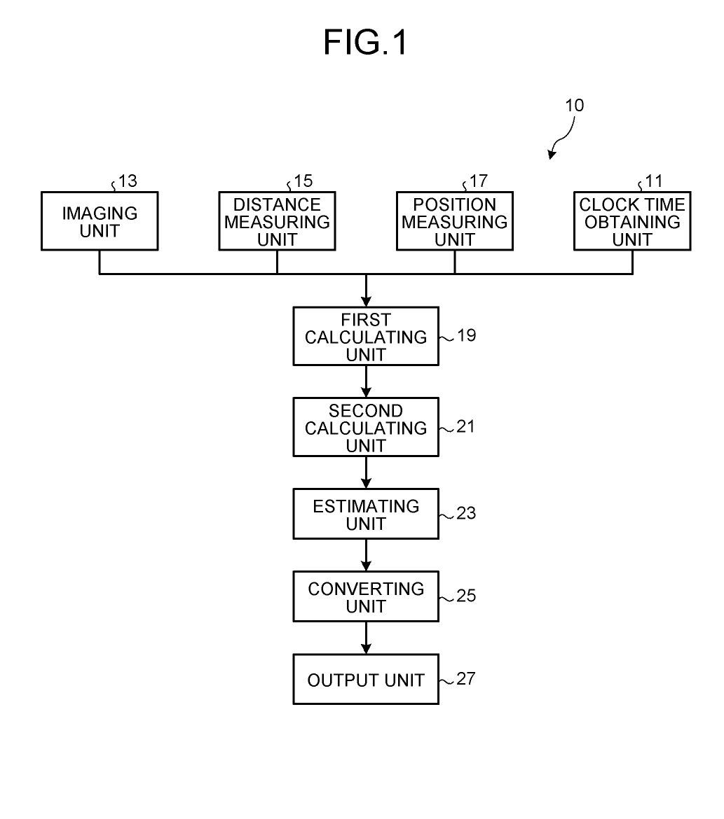

FIG. 1 is a configuration diagram illustrating an example of a measuring device 10 according to a first embodiment. As illustrated in FIG. 1, the measuring device 10 includes a clock time obtaining unit 11, an imaging unit 13, a distance measuring unit 15, a position measuring unit 17, a first calculating unit 19, a second calculating unit 21, an estimating unit 23, a converting unit 25, and an output unit 27.

The clock time obtaining unit 11, the first calculating unit 19, the second calculating unit 21, the estimating unit 23, and the converting unit 25 can be implemented by executing computer programs in a processor such as a central processing unit (CPU), that is, can be implemented using software; or can be implemented using hardware such as an integrated circuit (IC); or can be implemented using a combination of software and hardware.

The imaging unit 13 is implemented using an imaging device such as a visible camera, an infrared camera, or a multispectral camera. In the first embodiment, the explanation is given for an example in which a visible camera is used as the imaging unit 13. However, that is not the only possible case.

The distance measuring unit 15 can be implemented using a distance sensor such as a laser sensor, an ultrasonic sensor, or a millimeter-wave sensor that is capable of measuring the distance to an object. In the first embodiment, the explanation is given for an example in which a laser sensor is used as the distance measuring unit 15. However, that is not the only possible case.

The position measuring unit 17 can be implemented using a measuring device capable of measuring positions, such as a receiver that receives radio waves from the global positioning system (GPS). In the first embodiment, the explanation is given for an example in which a GPS receiver is used as the position measuring unit 17. However, that is not the only possible case.

The output unit 27 can be implemented using a display device, such as a liquid crystal display or a touchscreen display, meant for display output; or using a printing device, such as a printer, meant for print output; or using a combination of a display device and a printing device.

The clock time obtaining unit 11 obtains the clock time. For example, the clock time obtaining unit 11 can obtain the clock time externally from a network time protocol (NTP) server or from the global positioning system (GPS); or can measure the clock time on its own; or can combine both methods to obtain the clock time. Meanwhile, herein, as the clock time, it is possible to use either the actual clock time or the clock count used in counting.

The imaging unit 13 captures a target object for three-dimensional shape measurement (hereinafter, simply referred to as “object”) from a plurality of positions (hereinafter, referred to as “measuring positions”) and obtains a plurality of images. For example, the imaging unit 13 captures an object from n (n≧2) number of different measuring positions, and obtains n number of images {I(t₁), I(t₂), . . . , I(tₙ)}. Herein, each of t₁, t₂, . . . , tₙ is obtained by the clock time obtaining unit 11 and represents the measured clock time (imaging clock time) at the corresponding measuring position.

In the first embodiment, since the imaging unit 13 is a visible camera, an image I(t) is captured as a color image. However, that is not the only possible case. Alternatively, an image I(t) can be a monochromatic image; or can be a spectral image, such as an infrared image, other than a visible image; or can be a multispectral image formed by a combination of the abovementioned types of images.

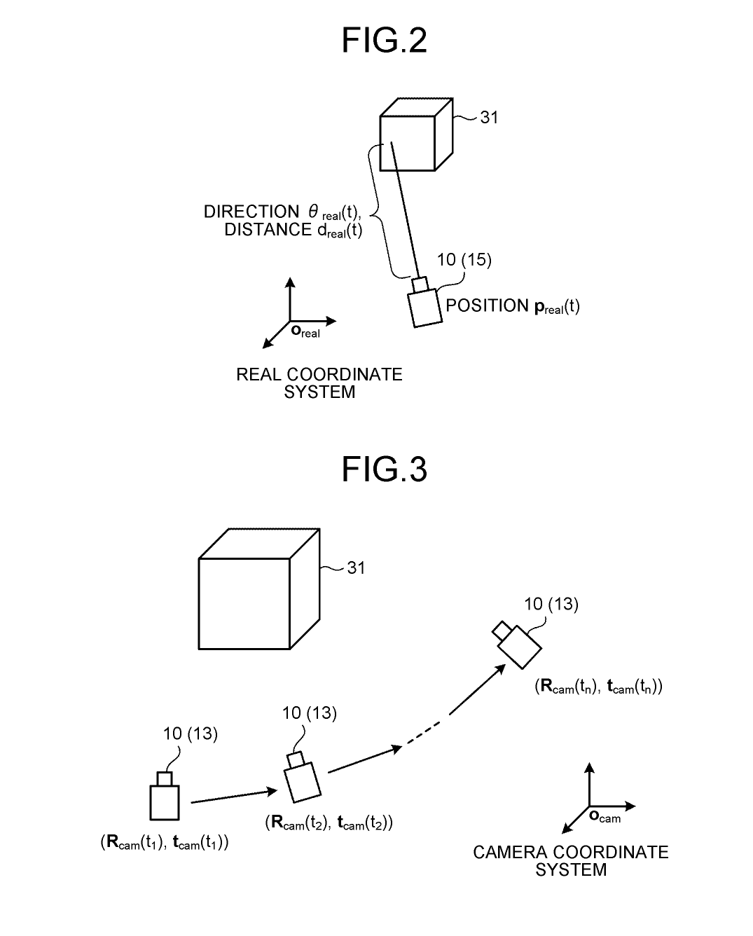

The distance measuring unit 15 measures the distance to the object from a plurality of measuring positions, and obtains a plurality of pieces of distance information. In the first embodiment, as illustrated in FIG. 2, each piece of the distance information is represented as a set of a direction θᵣₑₐₗ(t) and a distance dᵣₑₐₗ(t) from a measuring position of the measuring device 10 (more specifically, a measuring position of the distance measuring unit 15) to an object 31 (more specifically, to a target point for measurement of the object 31). As illustrated in FIG. 2, each piece of the distance information is expressed in a real coordinate system Oᵣₑₐₗ that is the coordinate system of the space (the three-dimensional space) in the real world.

For example, the distance measuring unit 15 measures the object from n number of different measuring positions and obtains n number of pieces of distance information {(θᵣₑₐₗ(t₁), dᵣₑₐₗ(t₁)), (θᵣₑₐₗ(t₂), dᵣₑₐₗ(t₂)), . . . , (θᵣₑₐₗ(tₙ), dᵣₑₐₗ(tₙ))}. Herein, each of t₁, t₂, . . . , tₙ is obtained by the clock time obtaining unit 11 and represents the measured clock time at the corresponding measuring position (i.e., represents a distance-measurement clock time).

However, the distance information is not limited to be configured with the direction and the distance. Alternatively, for example, the distance information can be configured with a shift vector from the measuring position to the object.

In the first embodiment, it is assumed that the distance measuring unit 15 performs calibration in advance, and the position and the orientation with respect to the imaging unit 13 is already known. With that, the distance measuring unit 15 becomes able to convert the distance information that has been measured into distance information based on the position and the orientation of the imaging unit 13.

The position measuring unit 17 measures a plurality of measuring positions and obtains a plurality of pieces of position information. In the first embodiment, as illustrated in FIG. 2, a piece of position information is represented as a measuring position pᵣₑₐₗ(t), which is a coordinate value indicating a single point within the space (three-dimensional space) in the real world. Moreover, as illustrated in FIG. 2, the position information is expressed in the real coordinate system Oᵣₑₐₗ.

For example, the position measuring unit 17 measures n number of different measuring positions and obtains n number of pieces of position information {pᵣₑₐₗ(t₁), pᵣₑₐₗ(t₂), . . . , pᵣₑₐₗ(tₙ)}. Herein, each of t₁, t₂, . . . , tₙ is obtained by the clock time obtaining unit 11 and represents the measured clock time at the corresponding measuring position (i.e., represents a position-measurement clock time).

The first calculating unit 19 makes use of a plurality of images captured by the imaging unit 13 and calculates the three-dimensional data of the object. Moreover, the first calculating unit 19 makes use of a plurality of images captured by the imaging unit 13 and further calculates position orientation information that indicates the position and the orientation of the imaging unit 13 at each of a plurality of measuring positions.

The three-dimensional data of an object can be treated as, for example, point cloud data which is a set of a number of points. Each point in the point cloud data has a coordinate value in the camera coordinate system, which is the coordinate system of the space (the three-dimensional space) captured by the imaging unit 13. Besides, each point in the point cloud data can also have intensity information and color information obtained from the images. With that, when a person sees the three-dimensional data, it becomes easier to understand the three-dimensional shape of the object. However, the three-dimensional data is not limited to the point cloud data. Alternatively, the three-dimensional data can be mesh data or polygon data, and it is possible to implement a known three-dimensional shape representation.

In the first embodiment, as illustrated in FIG. 3, it is assumed that the position orientation information is represented as a set of rotation matrix R_{cam}(t) and a translation vector t_{cam}(t) of the measuring device 10 (more specifically, the imaging unit 13). Herein, R_{cam}(t) represents the orientation of the imaging unit 13 and t_{cam}(t) represents the position of the imaging unit 13. Moreover, as illustrated in FIG. 3, the position information is expressed in a camera coordinate system O_{cam}.

For example, the first calculating unit 19 makes use of the n number of images {I(t₁), I(t₂), . . . , I(tₙ)} captured by the imaging unit 13 and calculates n number of pieces of position orientation information {(R_{cam}(t₁), t_{cam}(t₁)), (R_{cam}(t₂), t_{cam}(t₂)), . . . , (R_{cam}(tₙ), t_{cam}(tₙ))}, each of which is the position orientation information of a measuring position among n number of different measuring positions.

Meanwhile, in order to calculate the three-dimensional data of the object and to calculate the position and the orientation of the imaging unit 13 at each of a plurality of measuring positions (imaging timings) using the n number of images {I(t₁), I(t₂), . . . , I(tₙ)} captured by the imaging unit 13, a known method is implemented.

For example, if n number of images are captured in a continuous manner (for example, at 30 frames per second (fps)); then it is possible to implement the method disclosed in, for example, R. A. Newcombe et al., “DTAM: Dense Tracking and Mapping in Real-Time”, ICCV2011 so as to calculate the three-dimensional data of the object and to calculate the position and the orientation of the imaging unit 13 at each of a plurality of measuring positions (imaging timings).

Moreover, for example, if n number of images are not captured in a continuous manner; then it is possible to implement the method disclosed in, for example, S. Garwal et al. “Building Rome in a Day”, ICCV2009 so as to calculate the three-dimensional data of the object and to calculate the position and the orientation of the imaging unit 13 at each of a plurality of measuring positions (imaging timings).

Other than the methods mentioned above, many other methods are available to make use of the n number of images {I(t₁), I(t₂), . . . , I(tₙ)} captured by the imaging unit 13, and to calculate the three-dimensional data of the object as well as calculate the position and the orientation of the imaging unit 13 at each of a plurality of measuring positions (imaging timings).

The second calculating unit 21 calculates a degree of reliability of each of a plurality of pieces of distance information measured by the distance measuring unit 15 as well as calculates a degree of reliability of each of a plurality of pieces of position information measured by the position measuring unit 17.

Herein, the scale used in determining the real-world measurement of the three-dimensional data of an object can be obtained by comparing either the pieces of distance information measured by the distance measuring unit 15 or the pieces of position information measured by the position measuring unit 17 with the three-dimensional data calculated by the first calculating unit 19. However, if the scale is obtained using such pieces of distance information or position information which have large differences with the three-dimensional data, then it is obvious that a decline occurs in the accuracy of the scale. In that regard, in the first embodiment, the degrees of reliability of the pieces of distance information and the degrees of reliability of the pieces of position information are calculated. In the first embodiment, a degree of reliability is a non-negative value; and greater the value, greater is assumed to be the degree of reliability. However, that is not the only possible case.

Meanwhile, the scale is used in determining the real-world measurement of the three-dimensional data of an object, and represents the correspondence of unit lengths between the real coordinate system and the camera coordinate system. In the first embodiment, it is assumed that the scale represents the length in the real world corresponding to a unit length of the camera coordinate system. However, that is not the only possible case.

More particularly, the second calculating unit 21 performs shape fitting of the three-dimensional data, which is calculated by the first calculating unit 19, and a plurality of pieces of distance information, which is measured by the distance measuring unit 15; and calculates the degree of reliability of each piece of distance information according to the shape fitting result.

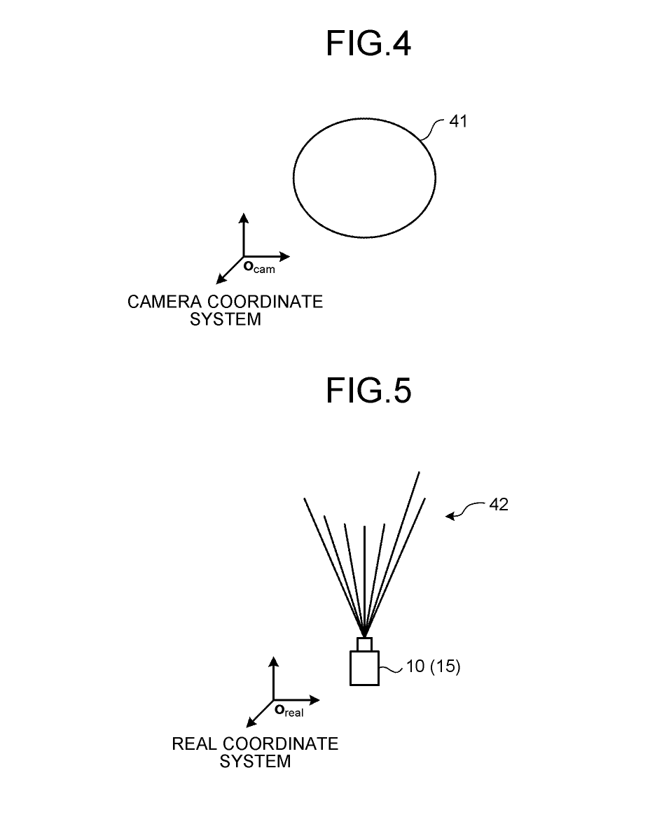

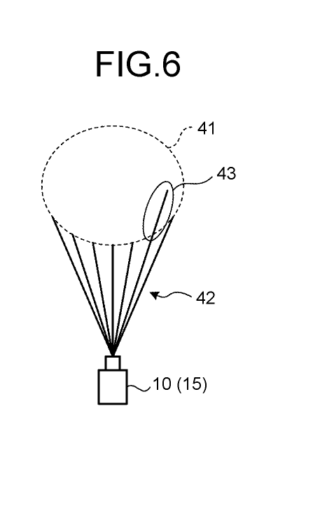

FIGS. 4 to 6 are explanatory diagrams illustrating an exemplary method of calculating the degree of reliability of each of a plurality of pieces of distance information according to the first embodiment. In FIG. 4 is illustrated a shape 41 of the three-dimensional data calculated by the first calculating unit 19. In FIG. 5 is illustrated a shape 42 of the three-dimensional point sequence that is identified by a plurality of pieces of distance information measured by the distance measuring unit 15. In FIG. 6 is illustrated the shape fitting result of the shape 41 and the shape 42.

Herein, the shape 41 illustrated in FIG. 4 and the shape 42 illustrated in FIG. 5 are ideally similar to each other. For that reason, the second calculating unit 21 fits together the shape 41 and the shape 42 in the optimal manner and compares them. With that, it becomes possible to find out the pieces of distance information having large differences with the three-dimensional data.

For example, in the example illustrated in FIG. 6, the three-dimensional point sequence of the shape 42 just about stops at the outer periphery of the shape 41. However, some part of that three-dimensional point sequence penetrates the outer periphery of the shape 41 (see a portion 43).

The pieces of distance information of such a three-dimensional point sequence are considered to be outlier and have low degrees of reliability. Hence, the second calculating unit 21 sets the degrees of reliability to “0”. More particularly, regarding the pieces of distance information of a three-dimensional point sequence in which the difference between the shape 41 and the shape 42 is greater than a threshold value T_{d}, the second calculating unit 21 can set the degrees of reliability to “0”. Moreover, regarding the pieces of distance information of a three-dimensional point sequence in which the difference between the shape 41 and the shape 42 is equal to or smaller than the threshold value T_{d}, the second calculating unit 21 can set the degrees of reliability in such a way that the degree of reliability monotonically increases as the difference goes on decreasing. Herein, the threshold value T_{d} can be determined from the magnitude of the distances indicated by the pieces of distance information and the specifications of the distance measuring unit 15 (such as a specification list of the distance measuring unit 15 issued by the manufacturer thereof).

Furthermore, the second calculating unit 21 performs shape fitting of the three-dimensional data, which is calculated by the first calculating unit 19, and a plurality of pieces of position information, which is measured by the position measuring unit 17; and calculates the degree of reliability of each piece of position information according to the shape fitting result.

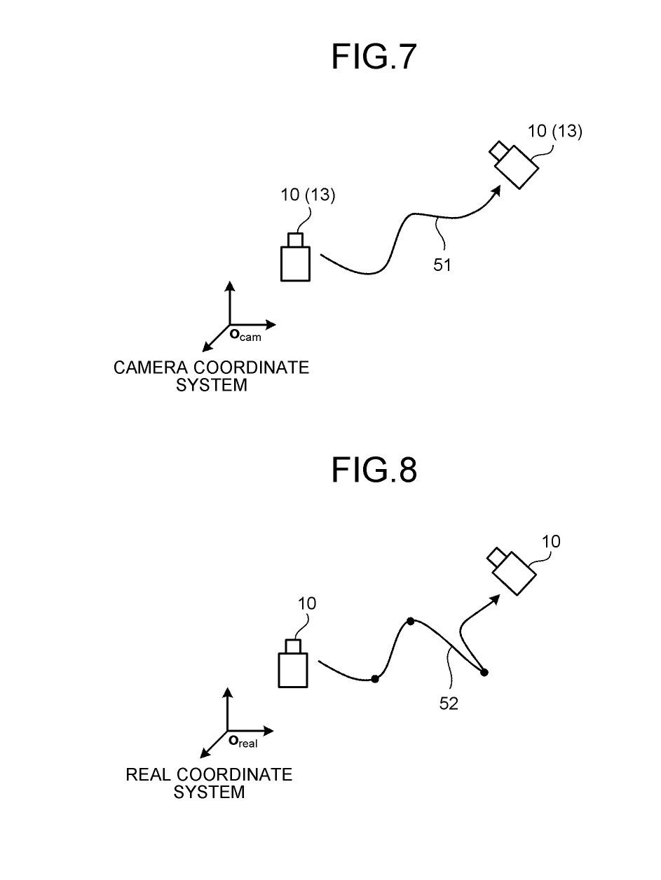

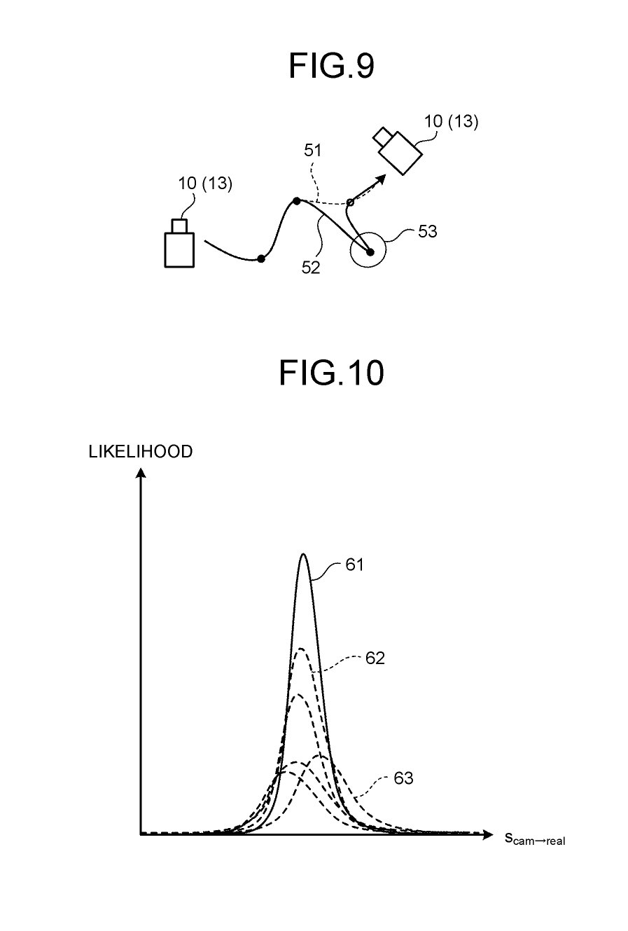

FIGS. 7 to 9 are explanatory diagrams illustrating an exemplary method of calculating the degree of reliability of each of a plurality of pieces of position information according to the first embodiment. In FIG. 7 is illustrated a motion trajectory 51 of the imaging unit 13 as identified from a plurality of pieces of position orientation information calculated by the first calculating unit 19. In FIG. 8 is illustrated a motion trajectory 52 of the measuring device 10 as identified from a plurality of pieces of position information measured by the position measuring unit 17. In FIG. 9 is illustrated the shape fitting result of the motion trajectory 51 and the motion trajectory 52.

The motion trajectory 51 illustrated in FIG. 7 and the motion trajectory 52 illustrated in FIG. 8 are ideally similar to each other. For that reason, the second calculating unit 21 fits together the motion trajectory 51 and the motion trajectory 52 in the optimal manner and compares them. With that, it becomes possible to find out the pieces of position information having large differences with the three-dimensional data.

For example, in the example illustrated in FIG. 9, the three-dimensional point sequence of the motion trajectory 52 just about fits on the motion trajectory 51. However, some part of that three-dimensional point sequence has deviated in a major way from the motion trajectory 51 (see a portion 53).

The pieces of position information of such a three-dimensional point sequence are considered to be outlier and have low degrees of reliability. Hence, the second calculating unit 21 sets the degrees of reliability to “0”. More particularly, regarding the pieces of position information of a three-dimensional point sequence in which the difference between the motion trajectory 51 and the motion trajectory 52 is greater than a threshold value Tₚ, the second calculating unit 21 can set the degrees of reliability to “0”. Moreover, regarding the pieces of position information of a three-dimensional point sequence in which the difference between the motion trajectory 51 and the motion trajectory 52 is equal to or smaller than the threshold value Tₚ, the second calculating unit 21 can set the degrees of reliability in such a way that the degree of reliability monotonically increases as the difference goes on decreasing. Herein, the threshold value Tₚ can be determined from the specifications of the position measuring unit 17 (such as a specification list of the position measuring unit 17 issued by the manufacturer thereof).

Although described later in detail, in the case of obtaining the scale from the position information measured by the position measuring unit 17, it is necessary to use two pieces of position information. Accordingly, the second calculating unit 21 needs to set the degrees of reliability for two sets of position information. Of those two degrees of reliability, simply the smaller degree of reliability can be used.

From among a plurality of pieces of distance information measured by the distance measuring unit 15 and a plurality of pieces of position information measured by the position measuring unit 17, the estimating unit 23 makes use of such pieces of distance information and such pieces of position information that have the degrees of reliability, which are calculated by the second calculating unit 21, greater than a predetermined value to thereby estimate the scale of the three-dimensional data calculated by the first calculating unit 19.

More particularly, the estimating unit 23 calculates candidate scales of the three-dimensional data from each piece of distance information having the degree of reliability greater than a predetermined value and each piece of position information having the degree of reliability greater than a predetermined value; generates a likelihood distribution of candidate scales of the three-dimensional data using the calculated candidate scales; and estimates the scale of the three-dimensional data using the likelihood distribution.

In the first embodiment, it is assumed that the likelihood distribution is obtained by superposing normal distributions, each of which corresponds to one of the candidate scales and has the standard deviation proportional to the estimation error of that candidate scale. However, that is not the only possible case.

Given below is the explanation about the estimation error included in a candidate scale at the time of calculating the candidate scale from the distance information.

In the case of calculating a candidate scale from the distance information, Equation (1) given below is used.

$${S}_{cam \to real} = \frac{{d}_{real} ( t )}{{d}_{cam}} \qquad ( 1 )$$

Herein, s_{cam}→ᵣₑₐₗ represents a candidate scale; and d_{cam} represents the distance corresponding to dᵣₑₐₗ(t) in the camera coordinate system. In the camera coordinate system, the distance d_{cam} is calculated by tracing from the position orientation information (R_{cam}(t), t_{cam}(t)) in the direction of θᵣₑₐₗ(t) of the distance information, and obtaining the distance to the three-dimensional data.

Herein, in practice, the distance dᵣₑₐₗ(t) as well as the distance d_{cam} includes an error that deviates from the true value. Hence, the candidate scale s_{cam}→ᵣₑₐₗ also happens to include an error (an estimation error). If eᵣₑₐₗ represents the error of dᵣₑₐₗ(t) and if e_{cam} represents the error of d_{cam}, then Equation (1) is transformed into Equation (2).

$${S}_{cam \to real} = \frac{{d}_{real} ( t ) \pm {e}_{real}}{{d}_{cam} \pm {e}_{cam}} \qquad ( 2 )$$

In general, in a laser sensor, as the distance dᵣₑₐₗ(t) increases, the ratio of the error eᵣₑₐₗ to the distance dᵣₑₐₗ(t) decreases. Hence, greater the value of the distance dᵣₑₐₗ(t) smaller becomes the estimation error included in the candidate scale s_{cam}→ᵣₑₐₗ.

Moreover, the error e_{cam} is dependent on the algorithm implemented to calculate the three-dimensional shape of the object, and does not depend on the distance d_{cam}. Hence, greater the value of distance d_{cam}, relatively smaller becomes the effect of the error e_{cam}.

Summing up, it can be understood that, greater the value of the distance dᵣₑₐₗ(t), smaller becomes the estimation error included in the candidate scale s_{cam}→ᵣₑₐₗ. In a distance sensor such as a laser sensor, since an effective measurement distance is set, it is not possible to limitlessly increase the distance dᵣₑₐₗ(t).

Given below is the explanation about the error included in a candidate scale at the time of calculating the candidate scale from the position information.

In the case of calculating a candidate scale from the position information, Equation (3) given below is used.

$${S}_{cam \to real} = \frac{‖ {p}_{real} ( {t}_{j}^{′} ) - {p}_{real} ( {t}_{i}^{′} ) ‖}{‖ {t}_{cam} ( {t}_{j} ) - {t}_{cam} ( {t}_{i} ) ‖} \qquad ( 3 )$$

Herein, tᵢ and tᵢ′ represent the substantially same clock time, while tⱼ and tⱼ′ (where i≠j) represent the substantially same clock time.

In practice, the measuring position Pᵣₑₐₗ(t) as well as the translation vector t_{cam}(t) includes an error that deviates from the true value. Hence, the candidate scale s_{cam}→ᵣₑₐₗ also happens to include an error (an estimation error). Then, in an identical manner to the case of the distance information, it can be understood that, greater the value of Pᵣₑₐₗ(tⱼ′)−Pᵣₑₐₗ(tᵢ′), that is, farther the position of the measuring device 10 at the clock time tᵢ from the position at the clock time tⱼ; smaller becomes the estimation error included in the candidate scale s_{cam}→ᵣₑₐₗ.

Moreover, the measuring error of the GPS used in the position measurement is not dependent on the position of the object. Hence, it can be understood that, farther the position of the measuring device 10 at the clock time tᵢ from the position at the clock time tⱼ; smaller becomes the effect of the measuring error.

Furthermore, since a GPS receiver can perform position measurement at any place at which GPS signals can be received, it is also possible limitlessly increase the value of Pᵣₑₐₗ(tⱼ′)−Pᵣₑₐₗ(tᵢ′).

In this way, in the case of calculating a candidate scale from the distance information, there exists a limitation called an effective measurement distance. In contrast, in the case of calculating a candidate scale from the position information, there is no limitation of the effective measurement distance. However, since the movement distance of the measuring device 10 is determined according to the size of the object or the environment, it is not always true that a candidate scale calculated from the position information has a smaller estimation error. For example, consider a case in which the measuring error of a piece of position information is 100 mm. In that case, in order to output the same accuracy as the accuracy of a piece of distance information of 1 m with the error of 1 mm, a movement of 100 m is required to perform measurement.

Thus, in order to accurately estimate the scale of the three-dimensional data, it is necessary to achieve a balance in using distance information that is effective while moving for a relatively short distance and using position information that is effective while moving for a relatively long distance.

In that regard, in the first embodiment, the estimating unit 23 makes use of the candidate scales calculated from the pieces of distance information having the degree of reliability greater than a predetermined value and the pieces of position information having the degree of reliability greater than a predetermined value; generates a likelihood distribution of candidate scales by superposing normal distributions, each of which corresponds to one of the candidate scales and has the standard deviation proportional to the estimation error of that candidate scale; and estimates the scale of the three-dimensional data using the likelihood distribution.

More particularly, the estimating unit 23 makes use of the candidate scales calculated from the pieces of distance information having the degrees of reliability greater than zero and the pieces of position information having the degrees of reliability greater than zero; and generates a likelihood distribution of candidate scales by superposing normal distributions, each of which corresponds to one of the candidate scales and has the standard deviation proportional to the estimation error of that candidate scale. According to the likelihood distribution, the candidate scales having smaller estimation errors are given more importance as compared to the candidate scales having larger estimation errors. For that reason, it becomes possible to accurately estimate the scale of the three-dimensional data.

FIG. 10 is a diagram illustrating an exemplary likelihood distribution according to the first embodiment. In the example illustrated in FIG. 10, a normal distribution 62 represents the normal distribution of a candidate scale having a small estimation error; a normal distribution 63 represents the normal distribution of a candidate scale having a large estimation error; and a normal distribution 61 represents the result of superposition of the normal distributions 62 and 63 and the like.

Then, the estimating unit 23 estimates the substantially largest value in the likelihood distribution to be the scale of the three-dimensional data. Herein, the estimating unit 23 can also implement robust estimation. In robust estimation, from among the candidate scales calculated from the pieces of distance information having the degrees of reliability greater than zero and the pieces of position information having the degrees of reliability greater than zero, estimation is performed with a candidate scale obtained by sampling. This operation is repeated, and the value having the highest likelihood is estimated to be the scale of the three-dimensional data.

Moreover, while superposing the normal distributions, the estimating unit 23 can perform weighted superposition. For example, the degrees of reliability can be used as weights. Alternatively, for example, if N_{d} represents the number of pieces of distance information having the degrees of reliability greater than zero and if Nₚ represents the number of pieces of position information having the degrees of reliability greater than zero, then the reciprocal of N_{d} can be used as the weight in the likelihood distribution obtained using the distance information and the reciprocal of Nₚ can be used as the weight in the likelihood distribution obtained using the position information.

Meanwhile, instead of calculating the likelihood distribution, the estimating unit 23 can estimate the average value of the candidate scales, which are calculated from the pieces of distance information having the degrees of reliability greater than zero and the pieces of position information having the degrees of reliability greater than zero, to be the scale of the three-dimensional data. Alternatively, the estimating unit 23 can estimate the weighted average value of the candidate scales, which are calculated from the pieces of distance information having the degrees of reliability greater than zero and the pieces of position information having the degrees of reliability greater than zero, to be the scale of the three-dimensional data.

The converting unit 25 makes use of the scale estimated by the estimating unit 23 and converts the scale of the three-dimensional data calculated by the first calculating unit 19 into the size in the real coordinate system.

The output unit 27 outputs the three-dimensional data that has the scale converted into the size in the real coordinate system. Herein, along with the three-dimensional data calculated by the first calculating unit 19, the output unit 27 can also output a reduction scale based on the scale estimated by the estimating unit 23.

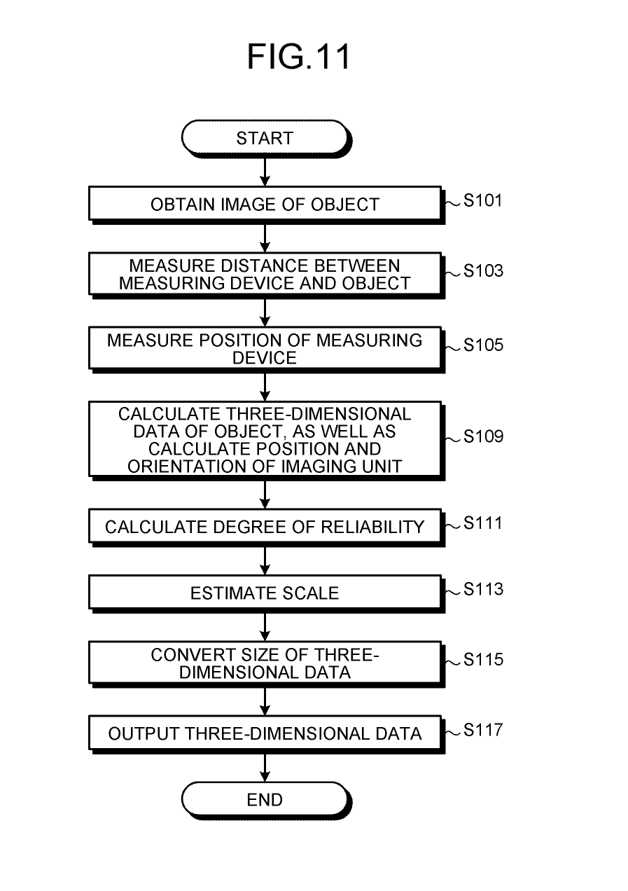

FIG. 11 is a flowchart for explaining an exemplary sequence of operations performed in the measuring device 10 according to the first embodiment.

Firstly, the imaging unit 13 captures an object from a measuring position and obtains an image (Step S101).

Then, the distance measuring unit 15 measures the distance to the object from the measuring position to obtain a piece of distance information (Step S103).

Subsequently, the position measuring unit 17 measures the measuring position to obtain a piece of position information (Step S105).

The operations from Step S101 to Step S105 are performed in a repeated manner for a number of times while changing the measuring position.

Then, using a plurality of images captured by the imaging unit 13, the first calculating unit 19 calculates position orientation information that indicates the position and the orientation of the imaging unit 13 at each of a plurality of measuring positions (Step S109).

Subsequently, the second calculating unit 21 calculates a degree of reliability of each of a plurality of pieces of distance information measured by the distance measuring unit 15 as well as calculates a degree of reliability of each of a plurality of pieces of position information measured by the position measuring unit 17 (Step S111).

Then, from among a plurality of pieces of distance information measured by the distance measuring unit 15 and a plurality of pieces of position information measured by the position measuring unit 17, the estimating unit 23 makes use of such pieces of distance information and such pieces of position information that have the degrees of reliability, which are calculated by the second calculating unit 21, greater than a predetermined value and estimates the scale of the three-dimensional data calculated by the first calculating unit 19 (Step S113).

Subsequently, the converting unit 25 makes use of the scale estimated by the estimating unit 23 and converts the scale of the three-dimensional data calculated by the first calculating unit 19 into the size in the real coordinate system (Step S115).

Then, the output unit 27 outputs the three-dimensional data that has the scale converted into the size in the real coordinate system (Step S117).

As described above, in the first embodiment, pieces of distance information having the degree of reliability greater than a predetermined value and pieces of position information having the degree of reliability greater than a predetermined value are used to estimate the scale of the three-dimensional data. Hence, irrespective of the movement distance of the measuring device, the scale can be obtained in an accurate manner.

Particularly, according to the first embodiment, the estimation errors of the candidate scales, which are calculated from the pieces of distance information having the degree of reliability greater than a predetermined value and the pieces of position information having the degree of reliability greater than a predetermined value, are taken into account while estimating the scale of the three-dimensional data. Hence, it becomes possible to obtain the scale in a more accurate manner.

### Second Embodiment

In a second embodiment, the explanation is given for an example in which motion information of a measuring device is also put to use. The following explanation is given with the focus on the differences with the first embodiment. Moreover, the constituent elements having identical functions to the constituent elements according to the first embodiment are referred to by the same names/reference numerals, and the explanation thereof is not repeated.

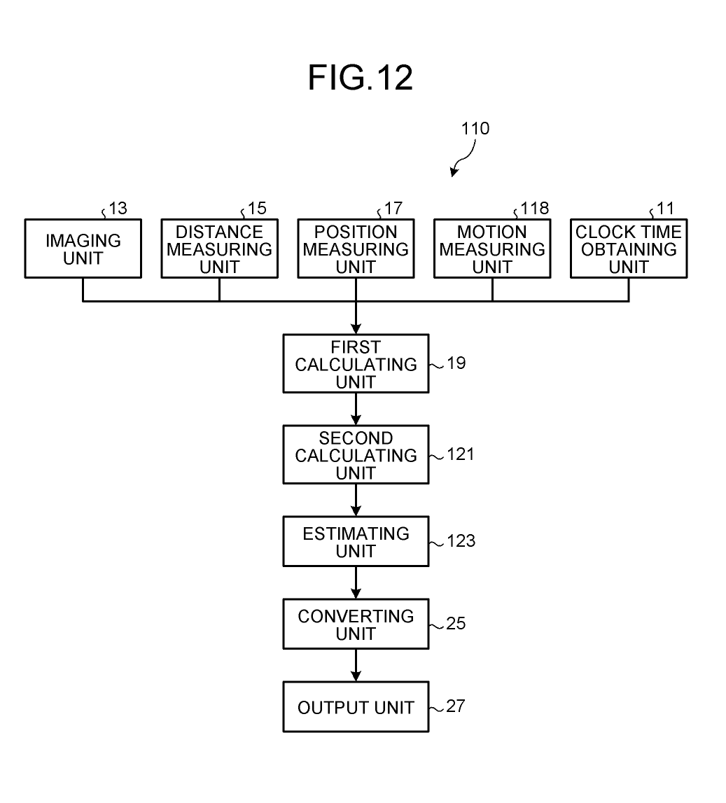

FIG. 12 is a configuration diagram illustrating an example of a measuring device 110 according to the second embodiment. As illustrated in FIG. 12, the second embodiment differs from the first embodiment in the way that the measuring device 110 further includes a motion measuring unit 118 as well as includes a second calculating unit 121 and an estimating unit 123.

The motion measuring unit 118 can be implemented using an inertial measurement unit (IMU) such as a gyro sensor.

The motion measuring unit 118 measures the motion of the measuring device 110 from a plurality of measuring positions to obtain a plurality of pieces of motion information. More particularly, the motion measuring unit 118 measures a triaxial acceleration a(t) and a triangular velocity w(t) at each measuring position of the measuring device 110; performs a numeric operation such as integration with respect to the triaxial acceleration a(t) and the triaxial angular velocity w(t); calculates a motion vector dᵣₑₐₗ(tᵢ, tⱼ) of the measuring device 110 between two arbitrary clock times tᵢ and tⱼ as well as calculates an orientation change angle qᵣₑₐₗ(tᵢ, tⱼ); and sets the motion vector dᵣₑₐₗ(tᵢ, tⱼ) and the orientation change angle qᵣₑₐₗ(tᵢ, tⱼ) as motion information. Herein, the motion information is expressed in the real coordinate system.

Herein, since the motion vector dᵣₑₐₗ(tᵢ, tⱼ) and the orientation change angle qᵣₑₐₗ(tᵢ, tⱼ) are subjected to integration, the measuring error goes on accumulating. Hence, the motion vector dᵣₑₐₗ(tᵢ, tⱼ) and the orientation change angle qᵣₑₐₗ(tᵢ, tⱼ) have the property that, longer the interval between the clock time tᵢ and the clock time tⱼ; larger is the error included in the motion vector dᵣₑₐₗ(tᵢ, tⱼ) and the orientation change angle qᵣₑₐₗ(tᵢ, tⱼ).

As far as the orientation change angle qᵣₑₐₗ(tᵢ, tⱼ) is concerned, it is possible to use various expressions. For example, it is possible to use either one of the following: the rotation matrix used in representing the orientation of the camera; the quaternion; the Rodriguez parameters; or the Euler angle. In the second embodiment, it is assumed that the orientation change angle qᵣₑₐₗ(tᵢ, tⱼ) is expressed using the rotation matrix. However, that is not the only possible case.

The first calculating unit 19 can make use of the motion vector dᵣₑₐₗ(tᵢ, tⱼ) and the orientation change angle qᵣₑₐₗ(tᵢ, tⱼ) at the time of calculating the position orientation information, which indicates the position and the orientation of the imaging unit 13 at each of a plurality of measuring positions.

The second calculating unit 121 further calculates the degree of reliability of each of a plurality of pieces of motion information. More particularly, the second calculating unit 121 performs shape fitting of the three-dimensional data, which is calculated by the first calculating unit 19, and a plurality of pieces of motion information, which is measured by the motion measuring unit 118; and calculates the degree of reliability of each piece of motion information according to the shape fitting result.

Herein, the trajectory of the motion vector dᵣₑₐₗ(tᵢ, tⱼ) of the motion measuring unit 118 and the trajectory of the translation vector t_{cam}(t) of the imaging unit 13 are ideally similar to each other. For that reason, the second calculating unit 121 fits together the trajectory of the motion vector dᵣₑₐₗ(tᵢ, tⱼ) and the translation vector t_{cam}(t) in the optimal manner and compares them. With that, it becomes possible to find out the pieces of motion information having large differences with the three-dimensional data.

Then, the pieces of motion information of such a three-dimensional point sequence that has deviated in a major way from the trajectory of the translation vector t_{cam}(t) are considered to be outlier and have low degrees of reliability. Hence, the second calculating unit 121 sets the degrees of reliability to “0”. More particularly, regarding the pieces of motion information of a three-dimensional point sequence in which the difference between the trajectory of the motion vector dᵣₑₐₗ(tᵢ, tⱼ) and the trajectory of the translation vector t_{cam}(t) is greater than a threshold value T_{d2}, the second calculating unit 121 can set the degrees of reliability to “0”.

Moreover, the orientation change angle qᵣₑₐₗ(tᵢ, tⱼ) of the motion measuring unit 118 ideally matches with the change from the orientation R_{cam}(tᵢ) of the imaging unit 13 to the orientation R_{cam}(tᵢ) of the imaging unit 13. Hence, the orientation change angle qᵣₑₐₗ(tᵢ, tⱼ) is compared with the change in orientation of the imaging unit 13, and the degree of reliability is set to “0” if the difference therebetween is large.

As described earlier, longer the interval between the clock time tᵢ and the clock time tⱼ; larger is the error included in the motion vector dᵣₑₐₗ(tᵢ, tⱼ) and the orientation change angle qᵣₑₐₗ(tᵢ, tⱼ). Accordingly, the second calculating unit 121 can set the degrees of reliability in such a way that the degree of reliability monotonically decreases as the interval between the clock time tᵢ and the clock time tⱼ goes on increasing.

From among a plurality of pieces of distance information measured by the distance measuring unit 15, a plurality of pieces of position information measured by the position measuring unit 17, and a plurality of pieces of motion information measured by the motion measuring unit 118; the estimating unit 23 makes use of such pieces of distance information, position information, and motion information that have the degrees of reliability, which are calculated by the second calculating unit 121, greater than a predetermined value and estimates the scale of the three-dimensional data calculated by the first calculating unit 19.

Given below is the explanation about the estimation error included in a candidate scale at the time of calculating the candidate scale from the motion information.

In the case of calculating a candidate scale from the motion information, Equation (4) given below is used.

$${S}_{cam \to real} = \frac{‖ {d}_{real} ( {t}_{i}^{′} , {t}_{j}^{′} ) ‖}{‖ {t}_{cam} ( {t}_{j} ) - {t}_{cam} ( {t}_{i} ) ‖} \qquad ( 4 )$$

As described earlier, longer the time interval, larger is the error included in the motion vector dᵣₑₐₗ(tᵢ′, tⱼ′). Consequently, it can be understood that, greater the movement distance and shorter the movement time, smaller becomes the estimation error included in the candidate scale s_{cam}→ᵣₑₐₗ.

Subsequently, the estimating unit 123 makes use of the candidate scales calculated from the pieces of distance information having the degree of reliability greater than a predetermined value, the pieces of position information having the degree of reliability greater than a predetermined value, and the pieces of motion information having the degree of reliability greater than a predetermined value; generates a likelihood distribution of candidate scales by superposing normal distributions, each of which corresponds to one of the candidate scales and has the standard deviation proportional to the estimation error of that candidate scale; and estimates the scale of the three-dimensional data using the likelihood distribution.

More particularly, the estimating unit 123 makes use of the candidate scales calculated from the pieces of distance information having the degrees of reliability greater than zero, the pieces of position information having the degrees of reliability greater than zero, and the pieces of motion information having the degrees of reliability greater than zero; and generates a likelihood distribution of candidate scales by superposing normal distributions, each of which corresponds to one of the candidate scales and has the standard deviation proportional to the estimation error of that candidate scale. Then, the estimating unit 123 estimates the substantially largest value in the likelihood distribution to be the scale of the three-dimensional data.

Moreover, while superposing the normal distributions, the estimating unit 123 can perform weighted superposition. For example, the degrees of reliability can be used as weights. Alternatively, for example, if N_{d} represents the number of pieces of distance information having the degrees of reliability greater than zero, if Nₚ represents the number of pieces of position information having the degrees of reliability greater than zero, and if Nₘ represents the number of pieces of motion information having the degrees of reliability greater than zero; then the reciprocal of N_{d} can be used as the weight in the likelihood distribution obtained using the distance information, the reciprocal of Nₚ can be used as the weight in the likelihood distribution obtained using the position information, and the reciprocal of Nₘ can be used as the weight in the likelihood distribution obtained using the motion information.

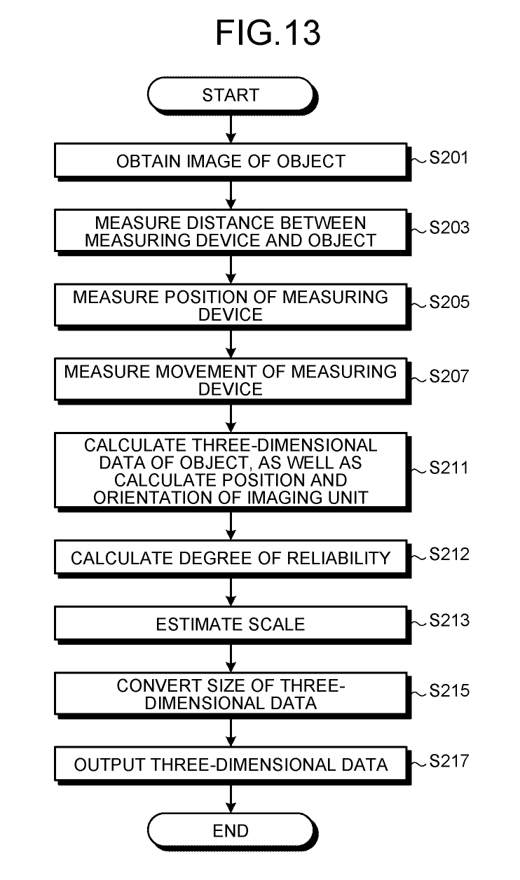

FIG. 13 is a flowchart for explaining an exemplary sequence of operations performed in the measuring device 110 according to the second embodiment.

Firstly, the operations performed at Step S201 to Step S205 are identical to the operations performed at Step S101 to Step S105 in the flowchart illustrated in FIG. 11.

Then, the motion measuring unit 118 measures the motion of the measuring device 110 at that measuring position, and obtains a piece of motion information (Step S207).

The operations from Step S201 to Step S207 are performed in a repeated manner for a number of times while changing the measuring position.

Then, the operation performed at Step S211 is identical to the operation performed at Step S109 in the flowchart illustrated in FIG. 11.

Subsequently, the second calculating unit 121 calculates a degree of reliability of each of a plurality of pieces of distance information measured by the distance measuring unit 15, calculates a degree of reliability of each of a plurality of pieces of position information measured by the position measuring unit 17, and calculates a degree of reliability of each of a plurality of pieces of motion information measured by the motion measuring unit 118 (Step S212).

Then, from among a plurality of pieces of distance information measured by the distance measuring unit 15, a plurality of pieces of position information measured by the position measuring unit 17, and a plurality of pieces of motion information measured by the motion measuring unit 118; the estimating unit 123 makes use of such pieces of distance information, position information, and motion information that have the degrees of reliability, which are calculated by the second calculating unit 121, greater than a predetermined value and estimates the scale of the three-dimensional data calculated by the first calculating unit 19 (Step S213).

The subsequent operations performed at Step S215 to Step S217 are identical to the operation performed at Step S115 to Step S117 in the flowchart illustrated in FIG. 11.

In this way, according to the second embodiment, since the motion information is also put to use, it becomes possible to obtain the scale in a more accurate manner.

Hardware Configuration

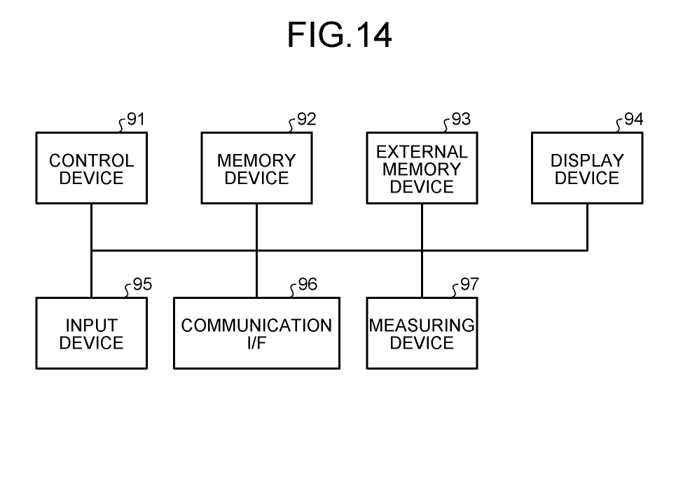

FIG. 14 is a block diagram illustrating a hardware configuration of the measuring device according to the embodiments described above. As illustrated in FIG. 14, the measuring device according to the embodiments described above has the hardware configuration of a commonly-used computer that includes a control device 91 such as a central processing unit (CPU); a memory device 92 such as a read only memory (ROM) or a random access memory (RAM); an external memory device 93 such as a hard disk drive (HDD) or a solid state drive (SSD); a display device 94 such as a display; an input device 95 such as a mouse or a keyboard; a communication I/F 96; and a measuring device 97 such as a visible camera, a laser sensor, or a GPS sensor.

The computer programs that are executed in the measuring device according to the embodiments described above are stored in advance in a ROM. Alternatively, the computer programs that are executed in the measuring device according to the embodiments described above can be recorded in the form of installable or executable files in a computer-readable recording medium such as a compact disk read only memory (CD-ROM), a compact disk readable (CD-R), a memory card, a digital versatile disk (DVD), or a flexible disk (FD). Still alternatively, the computer programs that are executed in the measuring device according to the embodiments described above can be saved as downloadable files on a computer connected to the Internet or can be made available for distribution through a network such as the Internet.

Meanwhile, the computer programs that are executed in the measuring device according to the embodiments described above contain a module for each of the abovementioned constituent elements to be implemented in a computer. As the actual hardware, for example, the control device 91 reads the computer programs from the external memory device 93 and runs them such that the computer programs are loaded in the memory device 92. As a result, the module for each of the abovementioned constituent elements is implemented in the computer.

As described above, according to the embodiments described above, it is possible to accurately obtain the scale which is used in determining the real-world measurement of the three-dimensional data of an object.

Unless contrary to the nature thereof, the steps of the flowcharts according to the embodiments described above can have a different execution sequence, can be executed in plurality at the same time, or can be executed in a different sequence every time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measuring device comprising:
an imaging unit configured to capture an object from a plurality of positions to obtain a plurality of images;
a distance measuring unit configured to measure a distance to the object from each of the plurality of positions to obtain a plurality of pieces of distance information;
a position measuring unit configured to measure the plurality of positions to obtain a plurality of pieces of position information;
a first calculator configured to calculate three-dimensional data of the object using the plurality of images;
a second calculator configured to calculate a degree of reliability of each of the plurality of pieces of distance information and each of the plurality of pieces of position information; and
an estimating unit configured to, from among the plurality of pieces of distance information and the plurality of pieces of position information, make use of pieces of distance information and pieces of position information each having the degree of reliability greater than a predetermined value to estimate a scale of the three-dimensional data.

2. The device according to claim 1, wherein the estimating unit is configured to
calculate a candidate scale of the three-dimensional data from each piece of distance information and each piece of position information having the degree of reliability greater than a predetermined value,
generate a likelihood distribution of candidate scales of the three-dimensional data using each calculated candidate scale, and
estimate the scale of the three-dimensional data using the likelihood distribution.

3. The device according to claim 2, wherein the likelihood distribution is obtained by superposing normal distributions, each of which corresponds to one of the candidate scales and has the standard deviation proportional to an estimation error of that candidate scale.

4. The device according to claim 2, wherein
the first calculating unit is configured to make use of the plurality of images to further calculate position orientation information that indicates the position and the orientation of the imaging unit at each of the plurality of measuring positions, and
in a case of calculating the candidate scale from a piece of position information having the degree of reliability greater than a predetermined value, the estimating unit calculates the candidate scale using position orientation information calculated at the same position as the position specified in the piece of position information.

5. The device according to claim 1, wherein the second calculator is configured to perform shape fitting of the three-dimensional data and the plurality of pieces of distance information, and calculates the degree of reliability of each of the plurality of pieces of distance information according to a shape fitting result.

6. The device according to claim 1, wherein the second calculator is configured to perform shape fitting of the three-dimensional data and the plurality of pieces of position information, and calculate the degree of reliability of each of the plurality of pieces of position information according to a shape fitting result.

7. The device according to claim 1, further comprising a measuring unit configured to measure motion of the measuring device at the plurality of positions to obtain a plurality of pieces of motion information, wherein
the second calculator is configured to further calculate a degree of reliability of each of the plurality of pieces of motion information, and
from among the plurality of pieces of distance information, the plurality of pieces of position information, and the plurality of pieces of motion information, the estimating unit is configured to make use of pieces of distance information, pieces of position information, and pieces of motion information each having the degree of reliability greater than a predetermined value to estimate the scale of the three-dimensional data.

8. The device according to claim 7, wherein the second calculator is configured to perform shape fitting of the three-dimensional data and the plurality of pieces of motion information, and calculate the degree of reliability of each of the plurality of pieces of motion information according to a shape fitting result.

9. The device according to claim 1, wherein
the distance measuring unit is configured to measure the distance to the object from each of the plurality of positions in a real coordinate system that is a coordinate system of a space in the real world,
the position measuring unit is configured to measure the plurality of positions in the real coordinate system,
the first calculator is configured to calculate the three-dimensional data in a camera coordinate system that is a coordinate system of the space captured by the imaging unit, and
the scale represents the correspondence of unit lengths between the real coordinate system and the camera coordinate system.

10. The device according to claim 9, further comprising:
a converter configured to convert the three-dimensional data into a size in the real coordinate system using the scale estimated by the estimating unit; and
an output unit is configured to output the three-dimensional data which has been converted into the size.
